(19) United States
(12) Patent Application Publication
(10) Pub. No.: US 2026/0248063 A1
(43) Pub. Date: Aug. 27, 2026

(54) Agricultural Harvesting Machine

(71) Applicant: CLAAS Saulgau GmbH, 88348 Bad Saulgau (DE)

(72) Inventors: Stefan Birkhofer, Stockach (DE); Stefan Sauter, Zwiefalten (DE)

(21) Appl. No.: 19/313,225

(22) Filed: Aug. 28, 2025

(30) Foreign Application Priority Data
Sep. 10, 2024 (DE) 102024126015.7

(51) Int. Cl. A01B 73/04; A01B 51/04

(52) U.S. Cl. CPC A01B 73/044; A01B 51/04

(57) ABSTRACT

Agricultural harvester (10), having a framework (11) which has a first portion (11a) on which a running gear (16) engages, and a second portion (11b) on which a drawbar (13) engages, wherein the two portions (11a, 11b) are displaceable relative to one another about a bending axis (27) extending in the transverse direction with the aid of a bending cylinder (26), having booms (19), wherein at least one boom (19) engages in each case on both sides of the framework (11) on the first portion (11a) of the framework in such a manner that for transferring the harvester (10) between a working position and a transport position the respective boom (19) is displaceable relative to the first portion (11a) of the framework (11), having working units (20), wherein at least one working unit displaceable conjointly with the respective boom (19) engages in each case on each of the booms (19), wherein the bending axis (27) which extends in the transverse direction of the harvester and about which the first portion (11a) and the second portion (11b) of the framework are displaceable relative to one another by activating the bending cylinder (26) when transferring the harvester between the working position and a headland position, when viewed in the towing direction or longitudinal direction of the harvester, is disposed or positioned in such a manner that in this headland position the working units (20) extend so as to ascend obliquely from rear to front when viewed in the towing direction of the harvester. FIG. 1

The invention relates to an agricultural harvester.

Agricultural harvesters that can be coupled to a towing vehicle in order to be moved by being pulled with the aid of the towing vehicle, thus pulled by the towing vehicle, are known in practice. Such agricultural harvesters, moved by being pulled by a towing vehicle, include in particular forage harvesters, for example windrowers or tedders.

DE 10 2020 106 804 A1 discloses a forage harvester designed as a merger or pickup belt rake. The forage harvester disclosed therein has a frame or framework divided into two portions, wherein a running gear engages on a first portion and a drawbar engages on a second portion. The two sections can be displaced relative to each other by means of a bending cylinder, specifically between a working position and a headland position. Further, booms engage on the second portion of the framework or frame on which the drawbar engages and working units engage on the booms. In the working position and headland position, the working units extend in the transverse direction of the harvester. In the transport position, the working units extend in the longitudinal direction of the harvester.

When the agricultural harvester of DE 10 2020 106 804 A1 is transferred proceeding from the working position to the headland position, the booms and the working units engaging on the booms are displaced and raised parallel to the working position. In the working position and in the headland position, the working units each extend in the horizontal direction.

There is demand for an agricultural harvester that can be advantageously transferred between the working position and the headland position. It is an object of the invention to achieve a corresponding agricultural harvester. This object is achieved by an agricultural harvester according to Claim 1.

The agricultural harvester according to the invention has a framework or a frame which has a first portion on which a running gear having a running gear axle engages, and a second portion on which a drawbar engages, wherein the two portions of the framework or frame are displaceable relative to one another about a bending axis extending in the transverse direction of the harvester with the aid of a bending cylinder.

The agricultural harvester according to the invention furthermore has booms, wherein at least one boom engages in each case on both sides of the framework or frame on the first portion of the framework or frame on which the running gear engages in such a manner that for transferring the harvester between a working position, in which the respective boom extends in the transverse direction of the harvester, and a transport position, in which the respective boom extends in the towing direction or longitudinal direction of the harvester, the respective boom is displaceable relative to the first portion of the framework or frame.

The agricultural harvester according to the invention has working units, wherein at least one working unit displaceable conjointly with the respective boom engages in each case on each of the booms.

In the agricultural harvester according to the invention, the bending axis which extends in the transverse direction of the harvester and about which the first portion and the second portion of the framework or frame are displaceable relative to one another by activating the bending cylinder when transferring the harvester between the working position and a headland position, in which the respective boom likewise extends in the transverse direction of the harvester, when viewed in the towing direction or longitudinal direction of the harvester, is disposed or positioned in such a manner that in this headland position the working units extend so as to ascend obliquely from rear to front when viewed in the towing direction or longitudinal direction of the harvester.

In the harvester according to the invention, the booms and, via the booms, the working units do not engage on the second portion of the framework or frame on which the drawbar engages, but on the first portion of the framework or frame on which the running gear engages. It is guaranteed as a result that in this headland position the working units, when viewed in the towing direction or longitudinal direction of the harvester, extend so as to ascend obliquely from rear to front, thus are not lifted from the ground only by way of a parallel displacement relative to the working position, as in the prior art, but are positioned obliquely relative to the horizontal direction, specifically so as to ascend from rear to front when viewed in the towing direction or longitudinal direction. As a result, the working units can be gently lifted from ground to be worked when transferring the harvester from the working position to this headland position. During the opposite transfer, proceeding from this headland position to the working position, the working units can be set down gently on the ground. Transferring the agricultural harvester between the working position and this headland position of the latter is performed only by operating the bending cylinder, such that the transfer can be carried out easily and reliably.

Preferably, the bending cylinder is retracted in the working position of the harvester, and is deployed in this headland position of the harvester. This is preferable for transferring the harvester between the working position and the transport position.

Preferably, the bending cylinder is configured to displace the two portions of the framework or frame relative to one another also for ground adaptation and/or ground relief of the working units in the working position of the harvester.

This allows for improved ground adaptation and ground relief, as well as an advantageously easy adaptation of the harvester to different operating conditions.

The running gear axle is preferably steerable. Owing to the defined position of the working units in this headland position of the harvester, in which the working units extend so as to ascend obliquely from rear to front when viewed in the towing direction or longitudinal direction of the harvester, an advantageous caster is generated on the steering axle, which, when the steering is activated, allows a side of the running gear on the outside of the curve, which due to mass inertia tends to move toward the ground to be worked, to be slightly lifted from the ground to be worked.

Preferably, the agricultural harvester is a forage harvester, in particular a merger or pickup belt rake, wherein a pickup and a belt conveyor segment engage as working unit on each of the booms. The invention is preferably used in a merger.

Preferred refinements of the invention are derived from the dependent claims and from the description hereunder. Exemplary embodiments of the invention are explained in more detail by means of the drawing, without being limited thereto. In the drawing:

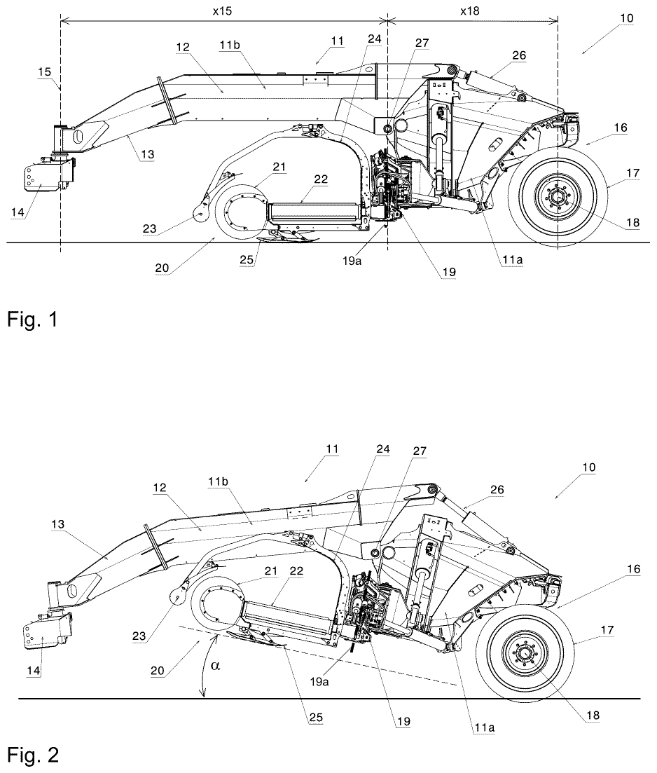

FIG. 1 shows a lateral view of an agricultural harvester according to the invention, in the working position of the latter;

FIG. 2 shows a lateral view of the agricultural harvester according to the invention, in a headland position of the latter.

The invention relates to an agricultural harvester 10. The agricultural harvester 10 is, in particular, a forage harvester that can be coupled to a towing vehicle (not shown) in order to be propelled by being pulled by a towing vehicle.

The harvester 10 shown in the figures is a merger, also referred to as a pickup belt rake.

The agricultural harvester 10 has a frame or framework, wherein the frame or framework 11 is divided into two portions 11a, 11b. The portion 11b of the framework or frame has a longitudinal member 12 which extends in the longitudinal direction or towing direction of the agricultural harvester 10. A drawbar 13, which serves to couple the agricultural harvester 10 to the towing vehicle by way of a coupling bracket 14, engages on the longitudinal member 12.

Once the harvester 10 is coupled to the towing vehicle, a relative movement between the drawbar 13 and the coupling bracket 14 about an axis 15 extending in the vertical direction of the agricultural harvester 10 is possible.

Furthermore, a relative movement between the coupling bracket 14 and the towing vehicle about an axis extending in the horizontal transverse direction is possible.

A running gear 16 with wheels 17 engages on the portion 11a of the framework or frame. The wheels 17 are rotatable about a running gear axle 18. When towing the agricultural harvester 10 with the aid of a towing vehicle, the wheels 17 of the running gear 16 are supported on ground and rotate about the running gear axle 18.

The agricultural harvester 10 furthermore has booms 19. On both sides of the framework or frame 11, specifically on both sides of the portion 11a of the framework or frame 11 on which the running gear 16 engages, at least one boom 19 engages in each case specifically in such a manner that for transferring the harvester 10 between a working position, in which the respective boom 19 extends in the transverse direction of the harvester 10, and a transport position, in which the respective boom 19 extends in the towing direction or longitudinal direction of the harvester 10, the respective boom 19 is displaceable relative to the portion 11a of the framework or frame 11.

The agricultural harvester 10 furthermore has working units 20. At least one working unit 20 displaceable conjointly with the respective boom 19 engages in each case on each boom 19, specifically when transferring the harvester 10 between the working position and the transport position, and when transferring the harvester 10 between the working position and a headland position.

In the exemplary embodiment shown, in which the agricultural harvester 10 is designed as a merger, each working unit 20 comprises a pickup 21 and a belt conveyor segment 20. Furthermore, the figures show roller retainers 23, which, when viewed in the towing direction or longitudinal direction of the harvester, are disposed in front of the respective pickup 21, and a cover 24, which, when viewed in the direction of travel of the agricultural harvester 10, is positioned behind the belt conveyor segments 22.

According to FIG. 1, which shows the agricultural harvester 10 in the working position, the working units 20 in the working position are supported by skids 25 on ground to be worked.

As already mentioned, the framework or frame 11 has the two portions 11a, 11b, wherein the running gear 16 and the working units 20 conjointly with the boom 19 engage on the portion 11a, and wherein the drawbar 13 engages on the portion 11b. These two portions 11a, 11b of the framework or frame 11 of the agricultural harvester 10 are displaceable relative to one another about an axis 27 extending in the transverse direction of the harvester with the aid of a bending cylinder 26, specifically when transferring the harvester 10 between the working position shown in FIG. 1 and the headland position shown in FIG. 2, in which the working units 20 extend in each case in the transverse direction of the agricultural harvester 10.

The axis 27 about which the two portions 11a, 11b are displaceable relative to one another with the aid of the bending cylinder 26 when transferring the agricultural harvester 10 between the working position of FIG. 1 and the headland position of FIG. 2, when viewed in the towing direction or longitudinal direction of the harvester, is in this exemplary embodiment positioned in front of the booms 19, or on the booms 19, specifically in the exemplary embodiment of FIG. 1 approximately above a central plane 19a of the booms 19. It is ensured in this way that in the headland position of the harvester 10—according to FIG. 2—the working units 20, when viewed in the towing direction or longitudinal direction of the harvester 10, extend so as to ascend obliquely from rear to front, thus are not parallel to the orientation of the working units 20 in the working position of the harvester 10 (see FIG. 1), but instead are inclined relative to this alignment in the working position.

When transferring the agricultural harvester 10 proceeding from the working position of FIG. 1 to the headland position of FIG. 2, the working units 20 can thus be lifted gently from the ground to be worked. Furthermore, when transferring the harvester 10 from the headland position shown in FIG. 2 to the working position shown in FIG. 1, the working units 20 can be placed gently on the ground to be worked.

This transfer of the harvester 10 between the working position and the headland position according to FIG. 2 is therefore carried out exclusively with the involvement of the bending cylinder 26. In accordance with FIG. 1, the bending cylinder 26 is retracted in the working position and deployed in the headland position in accordance with FIG. 2.

In the headland position of FIG. 2, the axis of rotation 18 of the running gear 16 is closer to the coupling bracket 14, so that the spacing from the towing vehicle is reduced and therefore the maneuverability of the towing unit is increased in this headland position.

In addition to the headland position according to FIG. 2, further actuators can be activated to lift the working units further off the ground. For example, the actuators for lifting the main booms, or actuators that serve to relieve the weight of the booms, can be provided as actuators for this purpose. This results in a further headland position which is composed of a superposition of the headland position according to FIG. 2 and the lifting of the booms 19.

The running gear axle 18 is preferably steerable. When the harvester 10 is transferred to the headland position, a caster is generated on a steering axle 18, which slightly lifts a side on the outside of the curve when the steering is activated. This is an advantage, as the side on the outside of the curve tends to be pulled toward the ground by mass inertia. The lift-off from the ground is therefore an advantage in order to prevent a collision with the ground.

In the exemplary embodiment shown, the axis 27 about which the two portions 11a, 11b of the running gear or frame 11 are able to be folded relative to one another with the aid of the bending cylinder 26, when viewed in the towing direction or longitudinal direction of the harvester 10, is positioned approximately above the central plane 19a of the booms 19. The same axis may also be positioned in front of the booms 19, in particular in front of articulation points between the portion 11a of the framework or frame and the booms 19, when viewed in the towing direction or longitudinal direction of the harvester 10. Thus, the booms 19 are articulated on the portion 11a of the framework or frame 11 in order to transfer the booms 19 relative to the portion 11a of the framework or frame between the working position and the transport position.

The axis 27 which extends in the transverse direction, about which the two portions 11a, 11b of the framework or frame 11 are able to be pivoted or bent relative to one another with the aid of the bending cylinder 26, can be disposed in the center, or approximately in the center, between the pivot axis 15 between the drawbar 13 and the coupling bracket 14 and the running gear axle 18. Then, when the axis 27 is disposed approximately in the center between the pivot axis 15 between the drawbar 13 and the coupling bracket 14 and the running gear axle 18, a spacing x15 of the axis 27 from the pivot axis 15 between the drawbar 13 and the coupling bracket 14 is approximately the size of a spacing x18 of the axis 27 from the running gear axle 18.

According to the invention, the axis 27 can be disposed in the towing direction or longitudinal direction of the harvester 10 in such a way that the ratio x15:x18 is approximately between 50:50 and 75:25.

However, it is particularly preferable to dispose the axis 27 in the towing direction or longitudinal direction of the harvester 10 in such a way that the axis 27 is positioned approximately above the central plane 19a of the booms 19. This means that a plumb line which is placed through the axis 27 in the working position of the harvester 10 coincides approximately with the central plane 19a of the boom 19.

The bending cylinder 26 can be configured to displace the two portions 11a, 11b of the framework or frame 11 relative to one another also for ground adaptation and/or ground relief of the working units 20 in the working position of the harvester. This can take place by continually or continuously controlling the bending cylinder 26 in a closed loop. Thus, in the agricultural harvester 10 according to the invention, only the bending cylinder 26 is utilized for transferring the agricultural harvester 10 between the working position and the headland position according to FIG. 2. Optionally, this bending cylinder 26 also serves for ground adaptation and/or ground relief of the working units 20.

Due to the arrangement of the working units 20 on the portion 11a of the framework or frame 11, on which also the running gear 16 engages, as well as due to the arrangement of the axis 27 about which the two portions 11a, 11b can be displaced relative to one another by way of the bending cylinder 26, it is guaranteed that in this headland position, the working units 20, when viewed in the longitudinal direction or towing direction of the harvester 10, extend so as to ascend obliquely from rear to front, and include an opening angle α relative to the ground. Owing to the arrangement of the bending axis 27 according to the invention, opening angles α of up to 15° (angular degrees) can be implemented, whereby the tines of the pickup 21 assume an advantageously large spacing from the ground, so that there is only a small risk of disturbing or damaging an already formed swath.

Accordingly, the working units 20 are lifted in a V-shaped manner, proceeding from the working position of FIG. 1 to the headland position of FIG. 2.

This allows the working units to be lifted and placed in a particularly gentle manner when transferring between the working position and this headland position.

Preferably, the axle 18 of the running gear 16 of the agricultural harvester 10 is designed as a steering axle. When transferring the agricultural harvester 10, proceeding from the working position to the headland position shown in FIG. 2, and when lifting the working units 20, a caster is generated on the axle 18 of the running gear 16 designed as a steering axle, which lifts the side on the outside of the curve when cornering.

In addition, when transferring the agricultural harvester 10 proceeding from the working position to the headland position of FIG. 2, the axle distance between the axle 18 of the landing gear 16 of the agricultural harvester 10 and a rear axle of the towing vehicle is shortened, as a result of which maneuverability is increased.

### LIST OF REFERENCE SIGNS

10 Harvester
11 Frame/framework
11a, 11b Portion
12 Longitudinal member
13 Drawbar
14 Coupling bracket
15 Axis
16 Running gear
17 Wheel
18 Running gear axle
19 Boom
19a Central plane
20 Working unit
21 Pickup
22 Belt conveyor segment
23 Roller retainers
24 Cover
25 Skid
26 Bending cylinder
27 Bending axis α Opening angle

1. An agricultural harvester (10) comprising:
framework or a frame (11) which has a first portion (11a) on which a running gear (16) engages, and a second portion (11b) on which a drawbar (13) engages, wherein the two portions (11a, 11b) are displaceable relative to one another about a bending axis (27) extending in the transverse direction of the harvester (10) with the aid of a bending cylinder (26),
booms (19), wherein at least one boom (19) engages in each case on both sides of the framework or frame (11) on the first portion (11a) of the framework or frame (11) on which the running gear engages (16) in such a manner that for transferring the harvester (10) between a working position, in which the respective boom (19) extends in the transverse direction of the harvester (10), and a transport position, in which the respective boom (19) extends in the towing direction or longitudinal direction of the harvester (10), the respective boom (19) is displaceable relative to the first portion (11a) of the framework or; and
working units (20), wherein at least one working unit (20) displaceable conjointly with the respective boom (19) engages in each case on each of the booms (19), wherein the bending axis (27) which extends in the transverse direction of the harvester (10) and about which the first portion (11a) and the second portion (11b) of the framework or frame (11) are displaceable relative to one another by activating the bending cylinder (26) when transferring the harvester (10) between the working position and a headland position, in which the respective boom (19) likewise extends in the transverse direction of the harvester (10), when viewed in the towing direction or longitudinal direction of the harvester (10), is disposed or positioned in such a manner that in this headland position the working units (20) extend so as to ascend obliquely from rear to front when viewed in the towing direction or longitudinal direction of the harvester (10).

2. The agricultural harvester (10) according to claim 1, characterized in that the bending cylinder (26) is retracted in the working position and deployed in the headland position.

3. The agricultural harvester (10) according to claim 1, characterized in that the bending axis (27) which extends in the transverse direction of the harvester (10) and about which the first portion (11a) and the second portion (11b) of the framework or frame (11) are displaceable relative to one another when transferring the harvester (10) between the working position and a headland position, when viewed in the towing direction or longitudinal direction of the harvester (10), is positioned approximately above a central plane (19a) of the booms (19).

4. The agricultural harvester (10) according to claim 1, characterized in that the bending axis (27) which extends in the transverse direction of the harvester (10), when viewed in the towing direction or longitudinal direction of the harvester (10), is positioned between a pivot axis (15) between the drawbar (13) and a coupling bracket (14) and a running gear axle (18) of the running gear (16), and a spacing x15 is created between the pivot axis (15) and the bending axis (27), and a spacing x18 is created between the bending axis (27) and the running gear axle (18), wherein the bending axis (27) is disposed in such a way that the ratio of the spacings x15:x18 is between 50:50 and 75:25.

5. The agricultural harvester (10) according to claim 1, characterized in that the running gear axle (18) of the running gear (16) is steerable.

6. The agricultural harvester (10) according to claim 1, characterized in that the bending cylinder (26) is configured to displace the two portions (11a, 11b) of the framework or frame (11) relative to one another also for ground adaptation and/or ground relief of the working units (20) in the working position of the harvester (10).

7. The agricultural harvester (10) according to claim 1, characterized in that the harvester is a forage harvester.

8. The agricultural harvester (10) according to claim 7, characterized in that the forage harvester is a merger or pickup belt rake, wherein a pickup (21) and a belt conveyor segment (22) engage as working unit (20) on each of the booms (17).
